(19) United States
(12) Patent Application Publication
(10) Pub. No.: US 2020/0192596 A1
(43) Pub. Date: Jun. 18, 2020

(54) BLOCKCHAIN DATA STORAGE METHOD AND APPARATUS

(71) Applicant: Alibaba Group Holding Limited, George Town (KY)

(72) Inventor: Xinying Yang, Hangzhou (CN)

(73) Assignee: Alibaba Group Holding Limited, George Town (KY)

(21) Appl. No.: 16/803,469

(22) Filed: Feb. 27, 2020

Related U.S. Application Data
(63) Continuation of application No. PCT/CN2020/071558, filed on Jan. 11, 2020.

(30) Foreign Application Priority Data
Jun. 3, 2019 (CN) 201910475986.0

(51) Int. Cl. G06F 3/06; G06F 16/23

(52) U.S. Cl. CPC G06F 3/0649; G06F 3/067; G06F 3/0611; G06F 16/2379

(57) ABSTRACT

Computer-implemented methods, computer-implemented systems, and non-transitory, computer-readable media for blockchain data storage. One computer-implemented method includes: obtaining, by a blockchain node of a blockchain network, data to be stored on a blockchain associated with the blockchain network; storing, by the blockchain node, the data to one or more solid state drives of the blockchain node; determining, by the blockchain node, expired blockchain data of the blockchain that has been stored in the one or more solid state drives of the blockchain node for over a predetermined period of time; and moving, by the blockchain node, the expired blockchain data from the one or more solid state drives of the blockchain node to one or more hard disk drives of the blockchain node.

### CROSS-REFERENCE TO RELATED APPLICATIONS

This application is a continuation of PCT Application No. PCT/CN2020/071558, filed on Jan. 11, 2020, which claims priority to Chinese Patent Application No. 201910475986.0, filed on Jun. 3, 2019, and each application is hereby incorporated by reference in its entirety.

### TECHNICAL FIELD

Implementations of the present specification relate to the field of information technologies, and in particular, to blockchain data storage methods and apparatuses.

### BACKGROUND

It is well known that nodes in a blockchain network need to store consistent blockchain data. Any node in the blockchain network can choose to use a distributed storage method to satisfy a requirement for massive blockchain data storage. In the distributed storage method, data that needs to be stored is distributed and stored on multiple storage devices, and storage load is shared by the multiple storage devices.

In practice, for example, for any node in a blockchain network, storage mediums of some storage devices associated with the node may be hard disk drives (HDD), some others may be solid-state drives (SSD). Costs of using the HDD are relatively low, but a data reading/writing speed is also relatively low, whereas costs of using the SSD are relatively high, but a data reading/writing speed is also relatively high.

Based on the existing technology, a more efficient blockchain data storage method is needed.

### SUMMARY

To alleviate a problem that an existing blockchain data storage method is relatively inefficient, implementations of the present specification provide blockchain data storage methods and apparatuses. Technical solutions are as follows:

According to a first aspect of the implementations of the present specification, a distributed storage-based blockchain data storage method is provided, where for any node in a blockchain network, multiple storage devices deployed for the node are categorized into a high-performance device group and a low-performance device group, a storage medium of each storage device in the high-performance device group is a solid-state drive, and a storage medium of each storage device in the low-performance device group is an HDD; and the method includes the following: allocating, by the node when obtaining blockchain data to be stored, the blockchain data to be stored to the high-performance device group for storage; and transferring expired blockchain data from the high-performance device group to the low-performance device group for storage, where the expired blockchain data is blockchain data that has been stored on the high-performance device group for more than predetermined duration.

According to a second aspect of the implementations of the present specification, a distributed storage-based blockchain data storage apparatus is provided, where the apparatus is any node in a blockchain network; multiple storage devices deployed for the apparatus are categorized into a high-performance device group and a low-performance device group, a storage medium of each storage device in the high-performance device group is a solid-state drive, and a storage medium of each storage device in the low-performance device group is an HDD; and the apparatus includes the following: a storage initialization module, configured to allocate, when obtaining blockchain data to be stored, the blockchain data to be stored to the high-performance device group for storage; and a storage transfer module, configured to transfer expired blockchain data from the high-performance device group to the low-performance device group for storage, where the expired blockchain data is blockchain data that has been stored on the high-performance device group for more than predetermined duration.

According to a third aspect of the implementations of the present specification, a distributed storage-based blockchain data storage system is provided, where the system includes a blockchain network that includes multiple nodes and multiple node devices deployed for each node; for any node in the blockchain network, the multiple storage devices are categorized into a high-performance device group and a low-performance device group, a storage medium of each storage device in the high-performance device group is a solid-state drive, and a storage medium of each storage device in the low-performance device group is an HDD; and when obtaining blockchain data to be stored, any node in the blockchain network allocates the blockchain data to be stored to the high-performance device group for storage, and transfers expired blockchain data from the high-performance device group to the low-performance device group for storage, where the expired blockchain data is blockchain data that has been stored on the high-performance device group for more than predetermined duration.

According to the technical solutions provided in the implementations of the present specification, for any node in the blockchain network, multiple storage devices deployed for the node are categorized into a high-performance device group and a low-performance device group. A storage medium of each storage device in the high-performance device group is a solid-state drive, and a storage medium of each storage device in the low-performance device group is an HDD. The node allocates blockchain data to be stored to the high-performance device group for storage, and the node transfers expired blockchain data that has been stored for a period of time from the high-performance device group to the low-performance device group.

According to the implementations of the present specification, newly generated blockchain data needs to be stored at the soonest (i.e., published to a blockchain at the soonest), and in addition, a data writing speed of a solid-state drive is relatively high. Therefore, storage devices using solid-state drives as storage mediums are used to store newly generated blockchain data in a centralized way, thereby taking full advantage of the high-performance of the solid-state drive, and improving the speed of storing blockchain data on the blockchain. In addition, expired blockchain data is transferred to a low-performance device group for storage, in other words, HDDs with relatively low costs are used to store the expired blockchain data, so that storage allocation is optimized.

It should be understood that the previous general description and the following detailed description are merely exemplary and illustrative, and cannot limit the implementations of the present specification.

In addition, any one of the implementations of the present specification does not need to achieve each of the previous effects.

### BRIEF DESCRIPTION OF DRAWINGS

To describe the technical solutions in the implementations of the present specification or in the existing technology more clearly, the following briefly describes the accompanying drawings required for describing the implementations or the existing technology. Clearly, the accompanying drawings in the following description merely show some implementations of the present specification, and a person of ordinary skill in the art can still derive other drawings from these accompanying drawings.

FIG. 1 is a schematic diagram illustrating an existing blockchain data storage method;

FIG. 2 is a schematic diagram illustrating a blockchain data storage method, according to some implementations of the present specification;

FIG. 3 is a schematic flowchart illustrating a blockchain data storage method, according to some implementations of the present specification;

FIG. 4 is a schematic structural diagram illustrating a blockchain data storage apparatus, according to some implementations of the present specification;

FIG. 5 is a schematic structural diagram illustrating a computer device for configuring the apparatus in the implementations of the present specification.

### DESCRIPTION OF IMPLEMENTATIONS

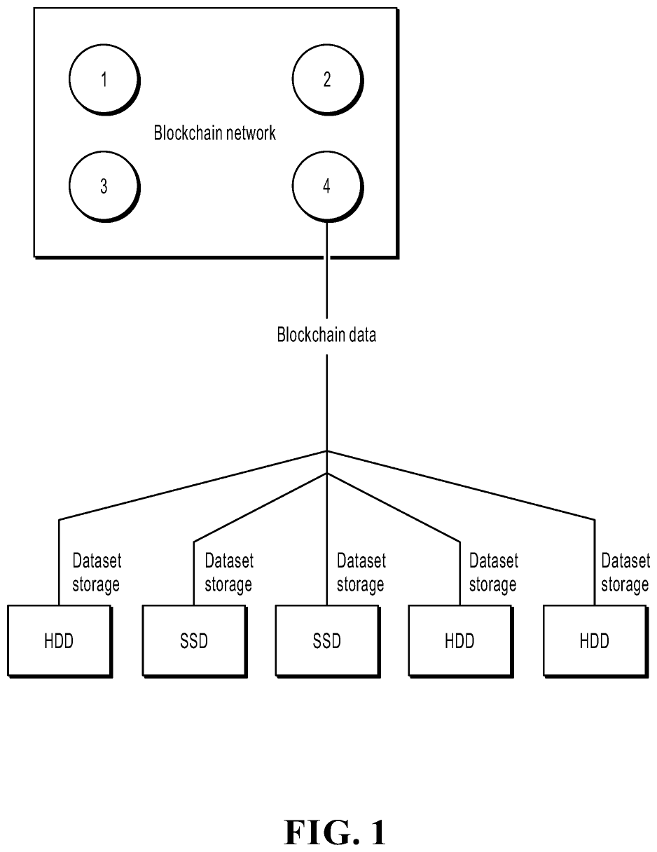

FIG. 1 is a schematic diagram illustrating an existing blockchain data storage method. As shown in FIG. 1, a blockchain network includes nodes 1 to 4. Node 4 is used as an example (nodes 1 to 3 are similar). Five storage devices are deployed for node 4, so that node 4 stores blockchain data generated by the blockchain network. Among the five storage devices, two storage devices use SSDs as storage mediums, and three storage devices use HDDs as storage mediums. When obtaining blockchain data to be stored, node 4 needs to divide the blockchain data (into five datasets), and then separately stores the datasets on the five storage devices.

Still referring to FIG. 1, clearly, a dataset is written into a storage device using an SSD as a storage medium at a relatively high speed, and a dataset is written into a storage device using an HDD as a storage medium at a relatively low speed. In practice, on the premise of fixed storage costs (i.e., not adding SSD storage devices), improving the speed of storing blockchain data on a blockchain is a technical problem to be improved upon.

On the premise of fixed storage costs, to alleviate the previous technical problem, performance optimization of existing storage devices using SSD can be performed to improve the speed of storing blockchain data on a blockchain.

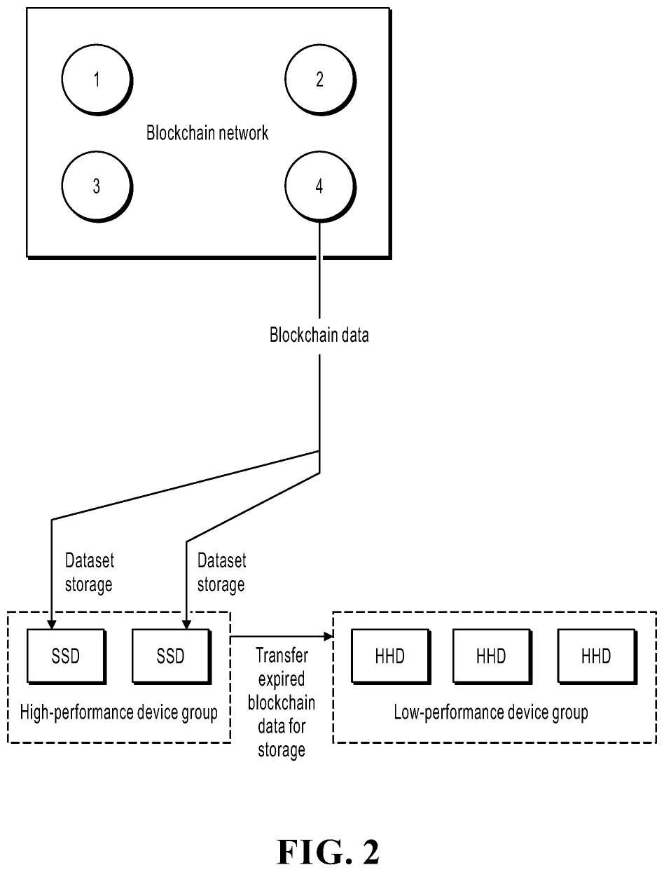

FIG. 2 is a schematic diagram illustrating a blockchain data storage method, according to some implementations of the present specification. As shown in FIG. 2, multiple existing storage devices can be grouped, storage devices using SSDs as storage mediums are used to store blockchain data in a centralized way, and expired blockchain data (blockchain data that has been stored for a period of time) is transferred to a storage device using an HDD as a storage medium to continue storage.

In other words, newly generated blockchain data is only stored on and written into an SSD storage device, so that it is stored on a blockchain at the soonest. Blockchain data that has been stored for a period of time is transferred to an HDD storage device for storage, so as to free up valuable SSD storage space for writing more newly generated blockchain data.

To make a person skilled in the art understand the technical solutions in the implementations of the present specification better, the following describes in detail the technical solutions in the implementations of the present specification with reference to the accompanying drawings in the implementations of the present specification. Clearly, the described implementations are merely some but not all of the implementations of the present specification. Other implementations obtained by a person of ordinary skill in the art based on the implementations of the present specification shall fall within the protection scope.

The technical solutions provided in the implementations of the present specification are described in detail below with reference to the accompanying drawings.

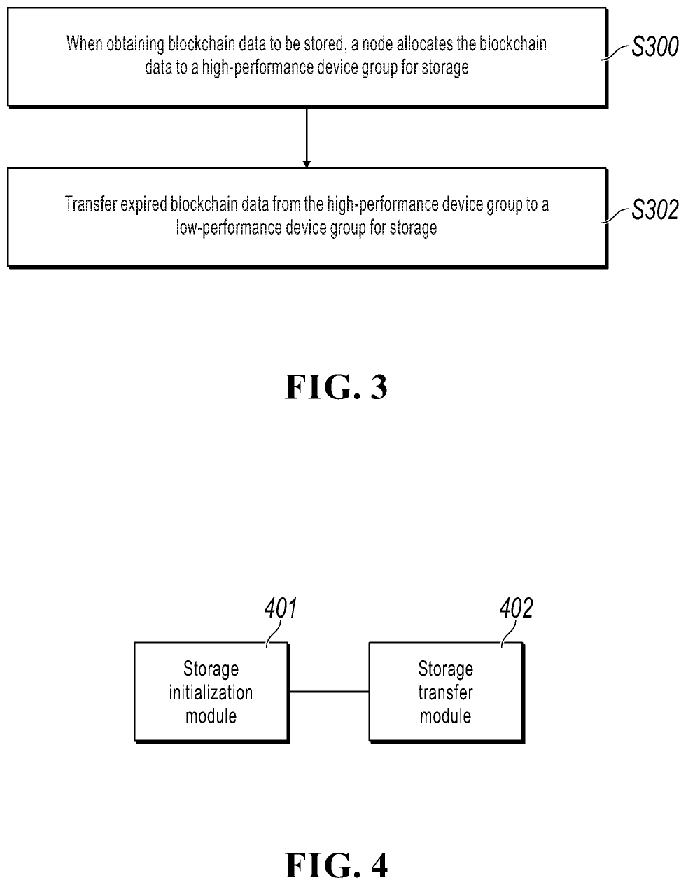

FIG. 3 is a schematic flowchart illustrating a blockchain data storage method, according to some implementations of the present specification. The method includes the following steps.

S300: For any node in a blockchain network, when obtaining blockchain data to be stored, the node allocates the blockchain data to a high-performance device group for storage.

In such implementations of the present specification, for any node in the blockchain network, multiple storage devices deployed for the node are categorized into a high-performance device group and a low-performance device group, a storage medium of each storage device in the high-performance device group is an SSD, and a storage medium of each storage device in the low-performance device group is an HDD.

It is worthwhile to note that the multiple storage devices deployed for the node include at least one storage device whose storage medium is an SSD and at least one storage device whose storage medium is an HDD. An objective of the present specification is to improve the speed of storing newly generated blockchain data on a blockchain without increasing storage devices under the assumption that the storage cost is fixed. Therefore, performance utilization of a storage device whose storage medium is SSD needs to be improved, and SSDs are used to store newly generated blockchain data in a centralized way, so that high-speed data read/write performance supported by the SSD is not left unused.

It is worthwhile to note that in the present specification, data writing refers to storing, modifying, or deleting data in a hard disk of a storage device. Data reading refers to reading data stored in a hard disk of a storage device. A data read/write speed of an SSD is relatively high, when efficiencies of storing, modifying, and reading data in a storage device using an SSD as a hard disk are relatively high.

In some implementations of the present specification, any node in the blockchain network can obtain blockchain data including a block to be published to a blockchain and state update data determined based on the block and used to update a blockchain world state. In addition, in some scenarios, the blockchain data can include only the block to be published to a blockchain.

In practice, storing a block locally means that the block is to be published on a blockchain. The faster the block is published to the blockchain, the sooner a deterministic service processing result can be fed back to a user.

The storage medium of each storage device in the high-performance device group is an SSD. Therefore, high-speed writing of blockchain data can be supported, and permanent storage of blockchain data can be completed at the soonest.

S302: Transfer expired blockchain data from the high-performance device group to the low-performance device group for storage.

Because the SSD has relatively high costs, storage space that can be provided is also limited. Therefore, with the accumulation of blockchain data, limited SSD storage space is insufficient to store more blockchain data. Therefore, in some implementations of the present specification, blockchain data that has been stored on the high-performance device group for more than predetermined duration is considered as expired blockchain data, and the expired blockchain data is transferred to the low-performance device group for storage.

A larger quantity of storage devices in the high-performance device group indicates larger storage space of an SSD and a larger quantity of blockchain data that can be stored, which means that the predetermined duration can be longer.

Because the expired blockchain data has been published to a blockchain, hence cannot be deleted and modified. In addition, the expired blockchain data is infrequently visited. Therefore, the expired blockchain data does not need to occupy valuable SSD storage space, hence can be transferred to HDD storage space for storage, so that storage configuration can be optimized.

In addition, it is worthwhile to note that each time a specified condition is satisfied, the node can trigger storage transfer of expired blockchain data. For example, each time a specified period elapses, the node determines expired blockchain data from blockchain data stored on the high-performance device group, and transfers the determined expired blockchain data from the high-performance device group to the low-performance device group for storage.

According to the method shown in FIG. 3, newly generated blockchain data needs to be stored at the soonest (i.e., published to a blockchain at the soonest), and in addition, a data writing speed of an SSD is relatively high. Therefore, storage devices using SSDs as storage mediums are used to store newly generated blockchain data in a centralized way, thereby taking full advantage of the high-performance of the solid-state drive, and improving the speed of storing blockchain data on the blockchain. In addition, expired blockchain data is transferred to a low-performance device group for storage, in other words, HHDs with relatively low costs are used to store the expired blockchain data, so that storage allocation is optimized.

In addition, in practice, a frequency of reading recently written blockchain data is usually greater than a frequency of reading expired blockchain data. For example, for transaction between users, a node in a blockchain network stores a transaction record of each transaction and a change of account balances of two users making a transaction as blockchain data. Generally, for each transaction, the users view a transaction record shortly after the transaction occurs to ensure the success of the transaction, and the users rarely view the transaction record after the transaction occurs for a long time.

Therefore, in such implementations of the present specification, recent blockchain data is stored on a high-performance device group, so that a user can read the blockchain data at a high speed. Expired blockchain data is stored on a low-performance device group. If it is occasionally necessary to read the expired blockchain data, a relatively low data reading speed is also acceptable in practice.

FIG. 4 is a schematic structural diagram illustrating a blockchain data storage apparatus, according to some implementations of the present specification. The apparatus is any node in a blockchain network.

Multiple storage devices deployed for the apparatus are categorized into a high-performance device group and a low-performance device group, a storage medium of each storage device in the high-performance device group is a solid-state drive, and a storage medium of each storage device in the low-performance device group is an HDD.

The apparatus includes the following: a storage initialization module 401, configured to allocate, when obtaining blockchain data to be stored, the blockchain data to be stored to the high-performance device group for storage; and a storage transfer module 402, configured to transfer expired blockchain data from the high-performance device group to the low-performance device group for storage, where the expired blockchain data is blockchain data that has been stored on the high-performance device group for more than predetermined duration.

The storage initialization module 401 obtains a block to be published to a blockchain and state update data determined based on the block and used to update a blockchain world state, and uses the block and the state update data as blockchain data to be stored.

Each time a specified period elapses, the storage transfer module 402 determines expired blockchain data from blockchain data stored on the high-performance device group, and transfers the determined expired blockchain data from the high-performance device group to the low-performance device group for storage.

The predetermined duration is positively correlated with a quantity of storage devices in the high-performance device group.

A blockchain data storage system includes a blockchain network that includes multiple nodes and multiple node devices deployed for each node.

For any node in the blockchain network, the multiple storage devices are categorized into a high-performance device group and a low-performance device group, a storage medium of each storage device in the high-performance device group is a solid-state drive, and a storage medium of each storage device in the low-performance device group is an HDD.

When obtaining blockchain data to be stored, any node in the blockchain network allocates the blockchain data to be stored to the high-performance device group for storage, and transfers expired blockchain data from the high-performance device group to the low-performance device group for storage, where the expired blockchain data is blockchain data that has been stored on the high-performance device group for more than predetermined duration.

Some implementations of the present specification further provide a computer device. The computer device includes at least a memory, a processor, and a computer program that is stored in the memory and can run on the processor, and the processor implements the method shown in FIG. 3 when executing the program.

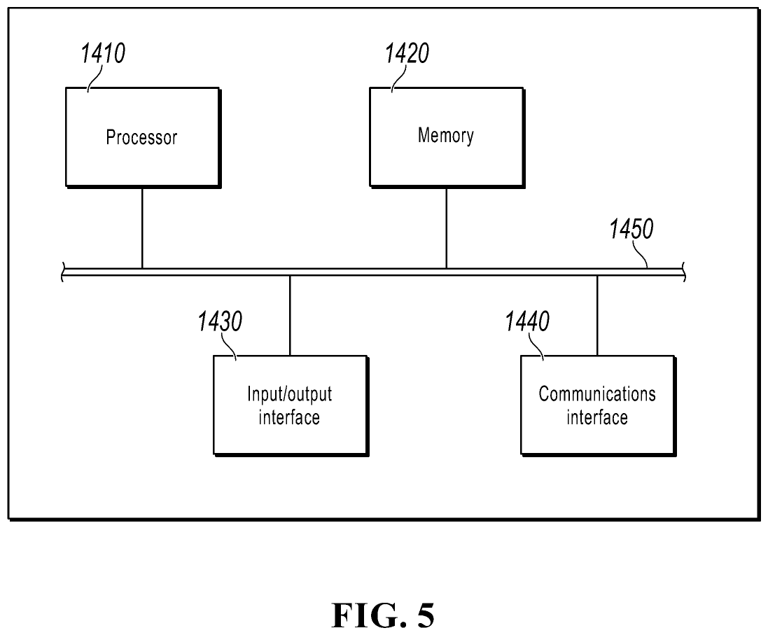

FIG. 5 is a more detailed schematic diagram illustrating a hardware structure of a computing device, according to some implementations of the present specification. The device can include a processor 1410, a memory 1420, an input/output interface 1430, a communications interface 1440, and a bus 1450. The processor 1410, the memory 1420, the input/output interface 1430, and the communications interface 1440 are communicatively connected to each other inside the device by using the bus 1450.

The processor 1410 can be implemented by using a general central processing unit (CPU), a microprocessor, an application-specific integrated circuit (ASIC), one or more integrated circuits, etc., and is configured to execute a related program, so as to implement the technical solutions provided in the implementations of the present specification.

The memory 1420 can be implemented by using a read-only memory (ROM), a random access memory (RAM), a static storage device, a dynamic storage device, etc. The memory 1420 can store an operating system and another application program. When the technical solutions provided in the implementations of the present specification are implemented by using software or firmware, related program code is stored in the memory 1420, and is invoked and executed by the processor 1410.

The input/output interface 1430 is configured to be connected to an input/output module, to input or output information. The input/output module (not shown in the figure) can be used as a component and configured in the device, or can be externally connected to the device, to provide a corresponding function. The input device can include a keyboard, a mouse cursor, a touchscreen, a microphone, various sensors, etc. The output device can include a monitor, a speaker, an oscillator, an indicator, etc.

The communications interface 1440 is configured to be connected to a communications module (not shown in the figure), to implement communication interaction between the device and another device. The communications module can perform wired communication (e.g., through a USB or a network cable), or can perform communication wirelessly (e.g., through a mobile network, Wi-Fi, or Bluetooth).

The bus 1450 includes a channel, used to transmit information between components (e.g., the processor 1410, the memory 1420, the input/output interface 1430, and the communications interface 1440) of the device.

It is worthwhile to note that although only the processor 1410, the memory 1420, the input/output interface 1430, the communications interface 1440, and the bus 1450 of the device are shown, during implementation, the device can further include other components required for implementing normal running. In addition, a person skilled in the art can understand that the device can include only components necessary for implementing the solutions in the implementations of the present specification, but does not necessarily include each component shown in the figure.

Some implementations of the present specification further provide a computer-readable storage medium. The computer-readable storage medium stores a computer program, and the program is executed by a processor to implement functions of the method shown in FIG. 3.

The computer-readable medium includes persistent, non-persistent, movable, and unmovable media that can store information by using any method or technology. The information can be a computer readable instruction, a data structure, a program module, or other data. Examples of the computer storage medium include but are not limited to a phase change RAM (PRAM), a static RAM (SRAM), a dynamic RAM (DRAM), a RAM of another type, a ROM, an electrically erasable programmable read only memory (EEPROM), a flash memory or another memory technology, a compact disc read-only memory (CD-ROM), a digital versatile disc (DVD), or another optical storage, a cassette, a cassette magnetic disk storage, or another magnetic storage device or any other non-transmission medium. The computer storage medium can be configured to store information that can be accessed by a computing device. As described in the present specification, the computer readable medium does not include computer readable transitory media such as a modulated data signal and a carrier.

It can be seen from the previous descriptions of the implementations that, a person skilled in the art can clearly understand that the implementations of the present specification can be implemented by using software and a necessary general hardware platform. Based on such an understanding, the technical solutions in the implementations of the present specification essentially or the part contributing to the existing technology can be implemented in a form of a software product. The computer software product can be stored in a storage medium, such as a ROM/RAM, a magnetic disk, or an optical disc, and includes several instructions for instructing a computer device (which can be a personal computer, a server, a network device, etc.) to perform the method described in the implementations of the present specification or in some parts of the implementations of the present specification.

The system, method, module, or unit illustrated in the previous implementations can be specifically implemented by using a computer chip or an entity, or can be implemented by using a product having a certain function. A typical implementation device is a computer, and the computer can be specifically a personal computer, a laptop computer, a cellular phone, a camera phone, a smartphone, a personal digital assistant, a media player, a navigation device, an email receiving and sending device, a game console, a tablet computer, a wearable device, or any combination of these devices.

The implementations of the present specification are described in a progressive way. For same or similar parts of the implementations, references can be made to the implementations. Each implementation focuses on a difference from other implementations. Particularly, apparatus implementations are similar to method implementations, and therefore are described briefly. For a related part, references can be made to some descriptions in the method implementation. The previously described method implementations are merely examples. The modules described as separate parts can or cannot be physically separate. During implementation of the solutions in the implementations of the present specification, functions of the modules can be implemented in one or more pieces of software and/or hardware. Some or all of the modules can be selected based on an actual need to implement the solutions of the implementations. A person of ordinary skill in the art can understand and implement the implementations of the present specification without creative efforts.

The previous descriptions are merely specific implementations of the implementations of the present specification. It is worthwhile to note that a person of ordinary skill in the art can further make several improvements or polishing without departing from the principle of the implementations of the present specification, and the improvements or polishing shall fall within the protection scope of the implementations of the present specification.

What is claimed is:

1. A computer-implemented method for blockchain data storage, comprising:
obtaining, by a blockchain node of a blockchain network, data to be stored on a blockchain associated with the blockchain network;
storing, by the blockchain node, the data to one or more solid state drives of the blockchain node;
determining, by the blockchain node, expired blockchain data of the blockchain that has been stored in the one or more solid state drives of the blockchain node for over a predetermined period of time; and
moving, by the blockchain node, the expired blockchain data from the one or more solid state drives of the blockchain node to one or more hard disk drives of the blockchain node.

2. The computer-implemented method of claim 1, wherein the data to be stored on the blockchain includes block data to be included in a current block of the blockchain and state data for updating a world state associated with the blockchain.

3. The computer-implemented method of claim 1, wherein the expired blockchain data is determined periodically by the blockchain with a period that equals the predetermined period of time.

4. The computer-implemented method of claim 1, wherein the predetermined period of time is positively correlated to a total storage capacity of the one or more solid state drives.

5. A computer-implemented system for blockchain data storage, comprising:
one or more computers; and
one or more computer memory devices interoperably coupled with the one or more computers and having tangible, non-transitory, machine-readable media storing one or more instructions that, when executed by the one or more computers, perform operations comprising:
obtaining, by a blockchain node of a blockchain network, data to be stored on a blockchain associated with the blockchain network;
storing, by the blockchain node, the data to one or more solid state drives of the blockchain node;
determining, by the blockchain node, expired blockchain data of the blockchain that has been stored in the one or more solid state drives of the blockchain node for over a predetermined period of time; and
moving, by the blockchain node, the expired blockchain data from the one or more solid state drives of the blockchain node to one or more hard disk drives of the blockchain node.

6. The computer-implemented system of claim 5, wherein the data to be stored on the blockchain includes block data to be included in a current block of the blockchain and state data for updating a world state associated with the blockchain.

7. The computer-implemented system of claim 5, wherein the expired blockchain data is determined periodically by the blockchain with a period that equals the predetermined period of time.

8. The computer-implemented system of claim 5, wherein the predetermined period of time is positively correlated to a total storage capacity of the one or more solid state drives.

9. A non-transitory, computer-readable medium storing one or more instructions executable by a computer system to perform operations for blockchain data storage, comprising:
obtaining, by a blockchain node of a blockchain network, data to be stored on a blockchain associated with the blockchain network;
storing, by the blockchain node, the data to one or more solid state drives of the blockchain node;
determining, by the blockchain node, expired blockchain data of the blockchain that has been stored in the one or more solid state drives of the blockchain node for over a predetermined period of time; and
moving, by the blockchain node, the expired blockchain data from the one or more solid state drives of the blockchain node to one or more hard disk drives of the blockchain node.

10. The non-transitory, computer-readable medium of claim 9, wherein the data to be stored on the blockchain includes block data to be included in a current block of the blockchain and state data for updating a world state associated with the blockchain.

11. The non-transitory, computer-readable medium of claim 9, wherein the expired blockchain data is determined periodically by the blockchain with a period that equals the predetermined period of time.

12. The non-transitory, computer-readable medium of claim 9, wherein the predetermined period of time is positively correlated to a total storage capacity of the one or more solid state drives.
